(19) United States
(12) Patent Application Publication
(10) Pub. No.: US 2025/0349186 A1
(43) Pub. Date: Nov. 13, 2025

(54) JACKPOT BONUS FEATURE WITH VISUAL CHANGE INDICATOR

(71) Applicant: Penn Interactive Ventures, LLC, Wyomissing, PA (US)

(72) Inventors: Cassidy Kammerer, Lawrence, KS (US); Mason McElroy, Las Vegas, NV (US); Andrew Duncan, Greenfield, MA (US); Nate Meltzer, Greenfield, MA (US)

(21) Appl. No.: 18/658,249

(22) Filed: May 8, 2024

(51) Int. Cl. G07F 17/32

(52) U.S. Cl. CPC G07F 17/3267; G07F 17/3213; G07F 17/3258

(57) ABSTRACT

According to an aspect, a computer-implemented method includes activating a gameplay mechanic to spin virtual reels displayed on a user interface and displaying a result of the spin. A first coinflip mechanic is activated based one detecting at least one wildcard symbol to determine whether to increment a current jackpot level and a display state of a jackpot level visual indicator is altered based on incrementing of the current jackpot level. A second coinflip mechanic is activated based one detecting the at least one wildcard symbol to determine whether to trigger a bonus game, where the first coinflip mechanic and the second coinflip mechanic each has a different weighting function selected based on the current jackpot level. The bonus game is activated based on determining that the second coinflip mechanic indicated triggering of the bonus game.

### BACKGROUND

This disclosure generally relates to electronic gaming, and more particularly, to systems and methods of playing an electronic game including a jackpot bonus feature with a visual change indicator.

Electronic gaming systems can be deployed as dedicated gaming machines that may be installed at casinos or other such locations. Online casino gaming can allow users to have a customized experience without traveling to a physical casino location. Gaming can involve the payment of credit that can be transferred between accounts and multiple games. Payment for gameplay and winning of games can increase or decrease the amount of credit that a player has available to cash out or use for other aspects, such as the purchase of merchandise, and/or payment for various products and services.

Some games have a multi-tiered experience, where playing a primary game can result in an opportunity to play a secondary or bonus game. Certain triggering events or gameplay combinations can allow a player to transition from playing the primary game to playing the secondary game. The secondary game can have a different set of rules with different graphics and effects from the primary game. Some games can involve player choices that combine skill and chance, while other games may rely upon a random number generator to randomly determine an outcome. Random outcomes may be based on a targeted return to player amount over many rounds of gameplay.

### SUMMARY

In one exemplary embodiment, a computer-implemented method for an electronic game including a jackpot bonus feature with a visual change indicator is provided. The method includes activating, by a processing device, a gameplay mechanic to spin a plurality of virtual reels displayed on a user interface and displaying a result of the spin. The method also includes activating, by the processing device, a first coinflip mechanic based one detecting at least one wildcard symbol in the result of the spin to determine whether to increment a current jackpot level and altering, by the processing device, a display state of a jackpot level visual indicator based on determining that the first coinflip mechanic indicated incrementing of the current jackpot level. The method further includes activating, by the processing device, a second coinflip mechanic based one detecting the at least one wildcard symbol in the result of the spin to determine whether to trigger a bonus game, where the first coinflip mechanic and the second coinflip mechanic each has a different weighting function selected based on the current jackpot level. The method also includes activating, by the processing device, the bonus game based on determining that the second coinflip mechanic indicated triggering of the bonus game.

In another exemplary embodiment, a system includes a memory with computer readable instructions and a processing device for executing the computer readable instructions. The computer readable instructions control the processing device to perform operations. The operations include activating a gameplay mechanic to spin a plurality of virtual reels displayed on a user interface, displaying a result of the spin, and activating a first coinflip mechanic based one detecting at least one wildcard symbol in the result of the spin to determine whether to increment a current jackpot level. The operations further include altering a display state of a jackpot level visual indicator based on determining that the first coinflip mechanic indicated incrementing of the current jackpot level, activating a second coinflip mechanic based one detecting the at least one wildcard symbol in the result of the spin to determine whether to trigger a bonus game, where the first coinflip mechanic and the second coinflip mechanic each has a different weighting function selected based on the current jackpot level, and activating the bonus game based on determining that the second coinflip mechanic indicated triggering of the bonus game.

In a further exemplary embodiment, a computer program product includes a storage medium embodied with computer program instructions that when executed by a computer cause the computer to implement: activating a gameplay mechanic to spin a plurality of virtual reels displayed on a user interface, displaying a result of the spin, and activating a first coinflip mechanic based one detecting at least one wildcard symbol in the result of the spin to determine whether to increment a current jackpot level. The computer program instructions that when executed by the computer further cause the computer to implement: altering a display state of a jackpot level visual indicator based on determining that the first coinflip mechanic indicated incrementing of the current jackpot level, activating a second coinflip mechanic based one detecting the at least one wildcard symbol in the result of the spin to determine whether to trigger a bonus game, where the first coinflip mechanic and the second coinflip mechanic each has a different weighting function selected based on the current jackpot level, and activating the bonus game based on determining that the second coinflip mechanic indicated triggering of the bonus game.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an electronic gaming system environment according to one or more embodiments described herein;

FIG. 2A depicts a user interface of a primary game with a jackpot level visual indicator in a first state according to one or more embodiments described herein;

FIG. 2B depicts a user interface of the primary game with the jackpot level visual indicator in a second state according to one or more embodiments described herein;

FIG. 2C depicts a user interface of the primary game with the jackpot level visual indicator in a third state according to one or more embodiments described herein;

FIG. 2D depicts a user interface of the primary game with the jackpot level visual indicator in a fourth state according to one or more embodiments described herein;

FIG. 3A depicts a user interface of a bonus game in a first state according to one or more embodiments described herein;

FIG. 3B depicts a user interface of the bonus game in a second state according to one or more embodiments described herein;

FIG. 3C depicts a user interface of the bonus game in a third state according to one or more embodiments described herein;

FIG. 3D depicts a user interface of the bonus game in a fourth state according to one or more embodiments described herein;

FIG. 4 is a flow diagram of a gameplay process with associated mechanics according to one or more embodiments described herein;

FIG. 5A illustrates an example of a changing background with pulsating movement of an animated character according to one or more embodiments described herein;

FIG. 5B illustrates an example of a glowing region around an animated character and a change in background according to one or more embodiments described herein;

FIG. 6 is a flow diagram of a method for bonus game activation according to one or more embodiments described herein; and

FIG. 7 is a block diagram of a processing system according to one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein relate to a jackpot bonus feature with a visual change indicator for an electronic gaming system. Player engagement with an electronic gaming system can relate to enjoyment and excitement created through visual and audio effects. Effects can include animation, light patterns, simulated machine sounds, coin sounds, and other such visual and audio outputs. In games of chance that include a primary and secondary or bonus game, players may not understand the odds of advancing from the primary game to the bonus game. For example, some games may include animation or other effects as a jackpot grows in value, but the visual and/or audio cues may not correlate to the odds of a player reaching the jackpot game. This lack of feedback can reduce player engagement.

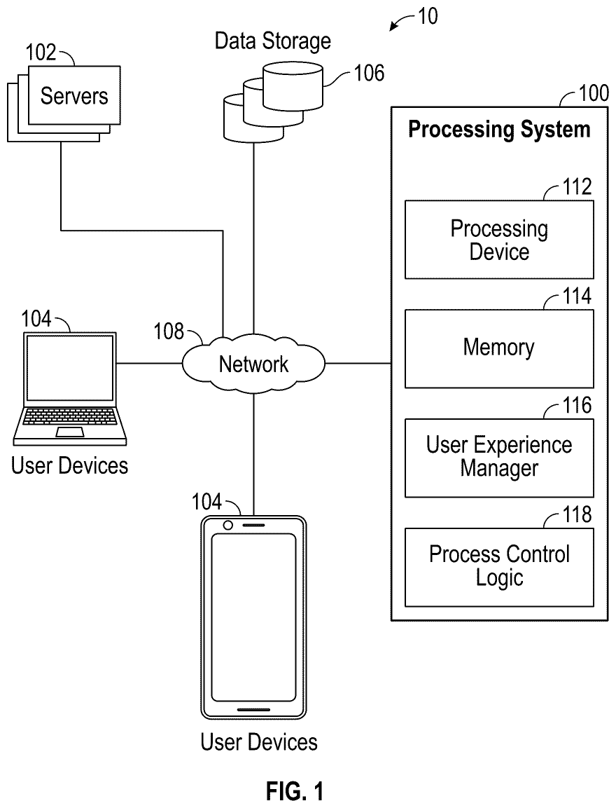

Turning now to FIG. 1, a system 10 is depicted in accordance with one or more embodiments. The system 10 includes a processing system 100 that can interact with one or more servers 102, user devices 104, and data sources 106 through a network 108. The processing system 100 can include a processing device 112 and memory 114. The memory 114 can include computer readable instructions. The processing device 112 can execute the computer readable instructions for controlling the processing device 112 to perform operations, such as executing a user experience manager 116, process control logic 118, and other applications and/or interfaces.

The various components, modules, applications, interfaces, etc. described regarding FIG. 1 (e.g., the user experience manager 116 and/or process control logic 118) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the components described herein can be a combination of hardware and programming. The programming can be processor executable instructions stored on a tangible memory, and the hardware can include the processing device 112 for executing those instructions. Thus, a system memory (e.g., memory 114) can store program instructions that when executed by the processing device 112 implement the manager, logic, and other functions described herein. Other components can also be utilized to include other features and functionality described in other examples herein. Further, aspects can be distributed between multiple processing devices and/or cloud computing based resources.

In one or more embodiments, the user experience manager 116 and/or process control logic 118 can be implemented on the processing system 100 of FIG. 1. In one or more other embodiments, the user experience manager 116 and/or process control logic 118 can be implemented, in whole or in part, using a cloud computing system (not shown). Cloud computing can supplement, support or replace some or all of the functionality of the elements of the processing system 100. Additionally, some or all of the functionality of the elements of the processing system 100 can be implemented as a cloud node of a cloud computing system. Thus, the processing system 100 can be distributed across multiple physical computer systems, which may be in different geographic locations.

The user experience manager 116 can manage allocation and deployment of resources to support application or web-based interfaces accessible by users through user devices 104. For example, gaming software with application programming interfaces (APIs) can reside on servers 102, and the user experience manager 116 can provide access to users through the user devices 104, where state data and other user data can be stored and retrieved through data storage 106. Thus, presentation layer aspects may display game-related content through a combination of the user experience manager 116, data stored on data storage 106, and software executed on or deployed by the servers 102. The process control logic 118 can control aspects of sharing user data across platforms, modifying user credits, presenting user-specific offers, and verifying user access/credentials. For example, the system 10 can blend aspects of physical and virtual experiences, such as online gaming, in-casino gaming, sportsbooks, and physical venues. In some aspects, the servers 102 can be partitioned into different service environments with associated data isolated in separate databases within the data storage 106. For instance, microservices with separate APIs can group online gaming with an online gaming database, a sportsbook API with a sportsbook database, and a casino API with a casino database. Core and edge services can manage transactions and data sharing between lower-level internally controlled core components and data with externally connected systems, such as user devices 104 and other third-party systems.

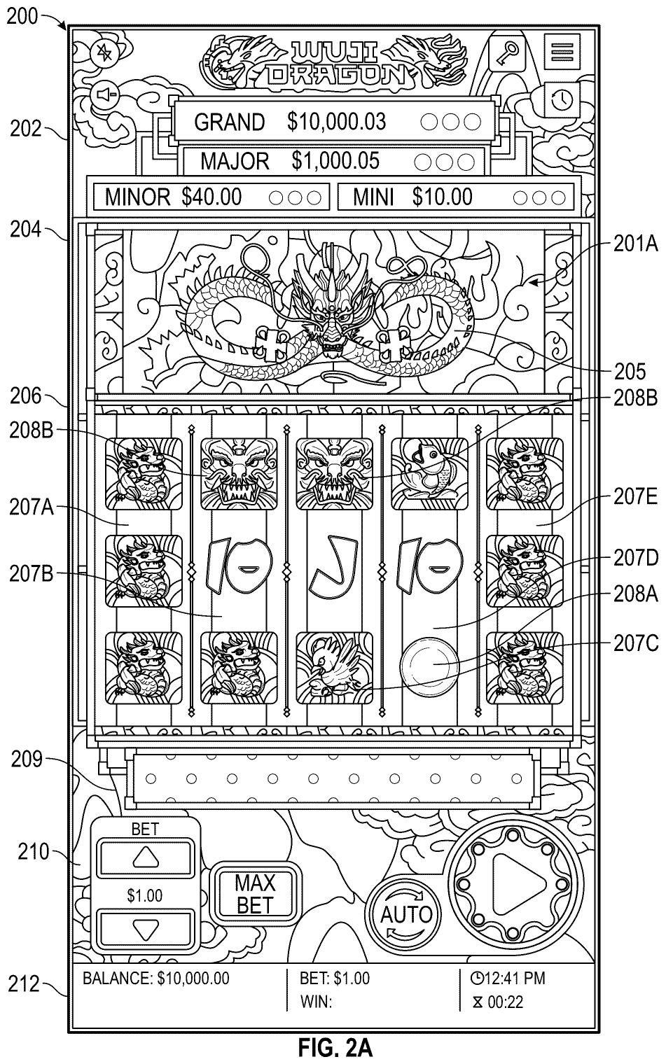

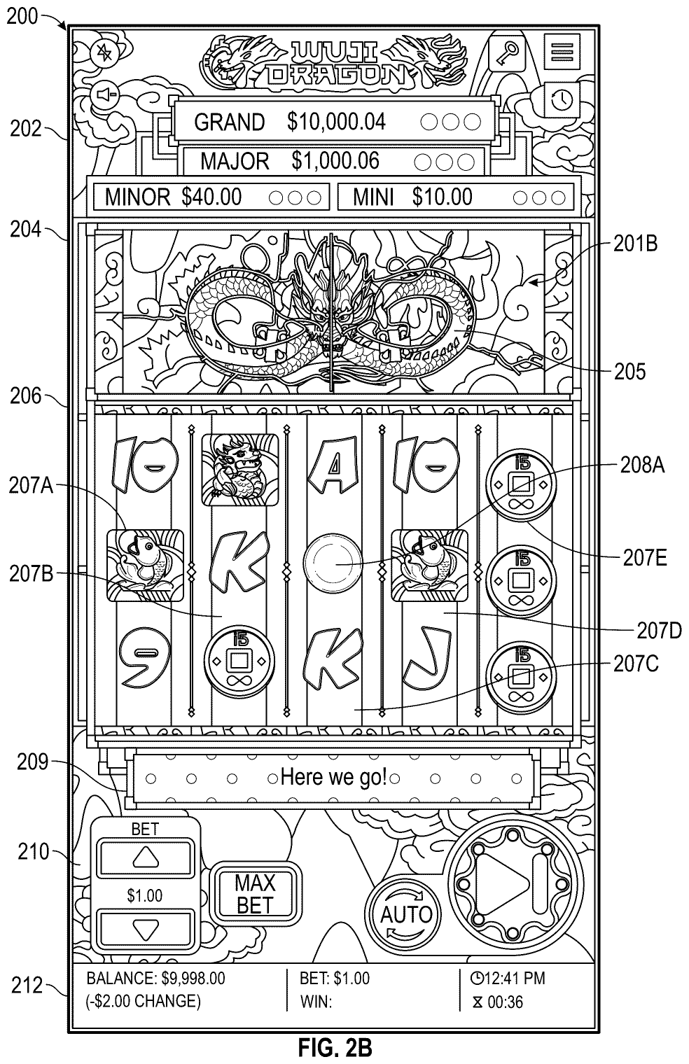

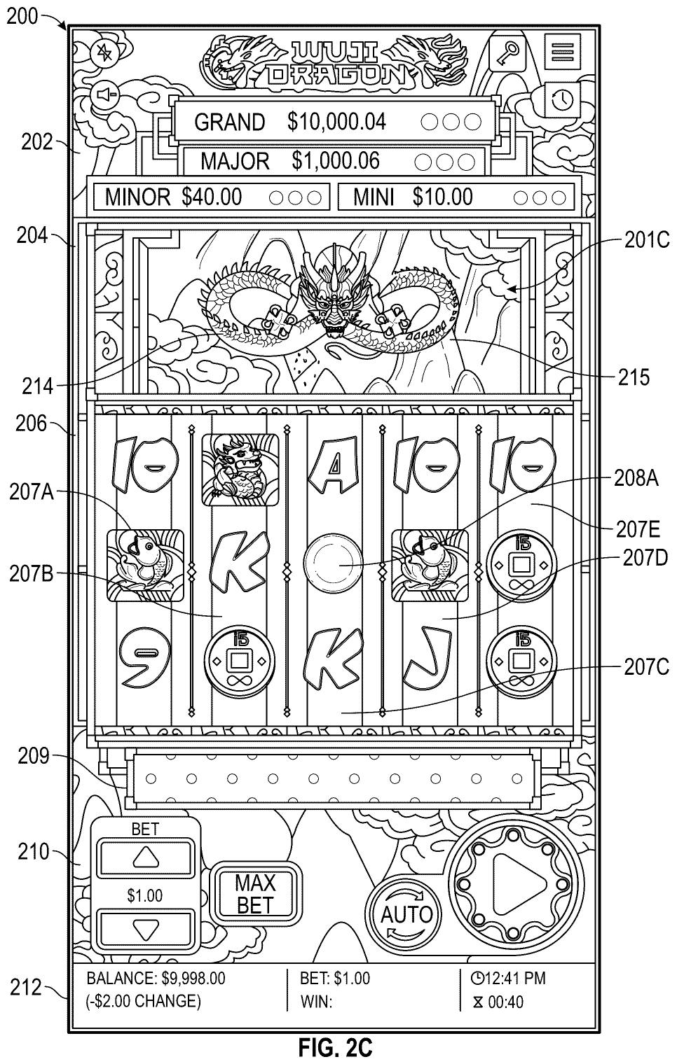

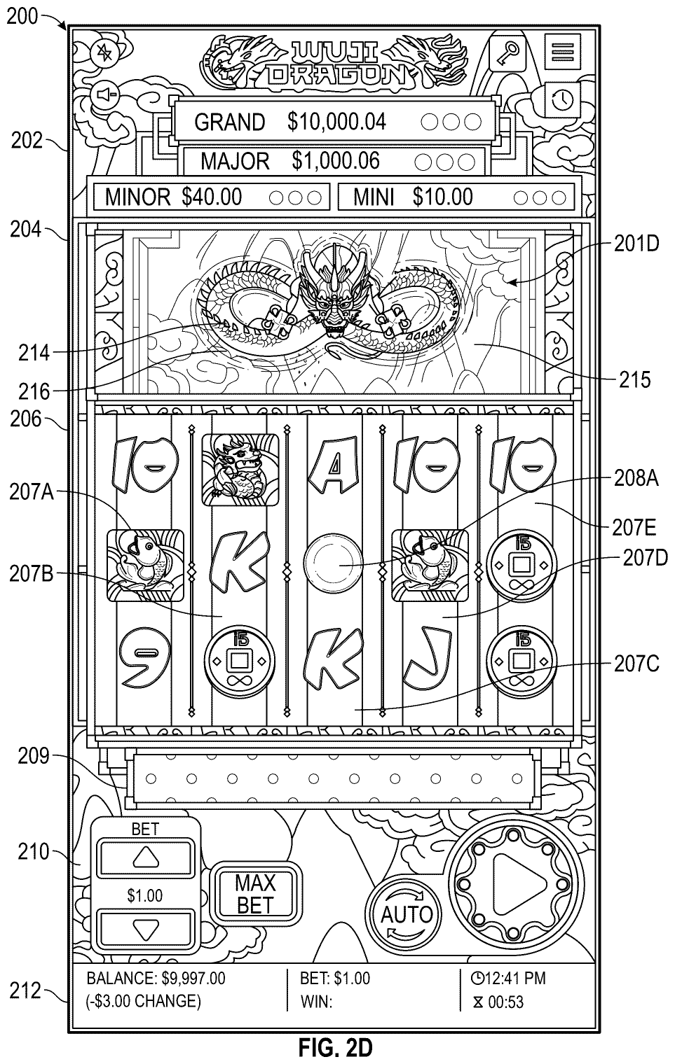

FIG. 2A depicts a user interface 200 of a primary game with a jackpot level visual indicator 204 in a first state 201A according to one or more embodiments. The user interface 200 can be generated by the user experience manager 116 of FIG. 1 for interactive use by users of the user devices 104 of FIG. 1. Game logic can be accessed through a gaming API of the servers 102 of FIG. 1, with state and credit tracking managed by the process control logic 118 of FIG. 1 or another component of the system 10 of FIG. 1.

In the example of FIG. 2A, the user interface 200 includes a jackpot amount indicator 202 that can express the value of multiple possible levels of jackpots which may be won upon transitioning from the primary game to a secondary game. As one example, there can be four jackpot levels, such as mini, minor, major, and grand. The potential value of each jackpot level can vary by multiples and/or orders of magnitude. In the example of FIG. 2A, the minor jackpot level may be about four times the mini jackpot level, while the major jackpot level may be about one hundred times the mini jackpot, and the grand jackpot may be about one thousand times the mini jackpot. The specific values of the jackpots can change and grow over time as gameplay continues for multiple rounds. Further, a bet level can change the amounts of the jackpot levels. For instance, maintaining a same bet amount between multiple rounds of playing the primary game can result in adjusting the jackpot levels along one sequence of jackpot growth, while adjusting the bet amount up can transition to a different jackpot growth sequence. Similarly, reducing the bet amount can result in shifting to a different jackpot growth sequence. For example, three rounds of one dollar bets may increment the jackpots to a first level, and shifting the bet level to five dollar bets can switch to a second sequence of jackpot level growth. If the betting level is shifted back to a one dollar level, the jackpots can revert to the first level.

In the example of FIG. 2A, the user interface 200 can include a main gameplay region 206, where symbols of a plurality of virtual reels 207A, 207B, 207C, 207D, 207E can be displayed during and after a spin event occurs. As one example, each of the virtual reels 207A-207E can display three symbols upon a spin event, which can result in displaying a three-by-five grid of symbols per spin. Wins can pay in any position from left to right on adjacent virtual reels 207A-207E, such as a match-three combination. One or more wild symbols 208A can appear as a result of a spin during game play. In some aspects, the wild symbols 208A can be limited to appearing on virtual reels 207B, 207C, 207D. The wild symbols 208A can take any value, such that a matching pair of symbols to the left and right of the wild symbol 208A can result in a three-of-a-kind win. Various gaming symbols can be included on the virtual reels 207A-207E, such as card values (e.g., 9, 10, J, Q, K, A), coins, gold/colored item images, and the like. The various symbols can correspond to prize values, which may be partitioned into minor and major prizes. As one example, card values can be minor reel items, while coins and gold/colored item images can be major reel items. The probability of particular reel items appearing can differ depending on the associated payout and bet level, for example.

Another type of special symbol can include a free spin symbol 208B. In some aspects, 3, 4, or 5 free spin symbols 208B on adjacent virtual reels 207A-207E, starting with the leftmost reel, can result in awarding one or more free games (e.g., ten free games) during the primary game. The wild symbols 208A can also be used to substitute for the free spin symbol 208B. When free spins are used, the background and/or other aspects of the user interface 200 can change to visually indicate that a free spin is being used rather than a paid bet. Further, some symbols may not appear when a free spin is used, such as removing the card symbols from the virtual reels 207A-207E.

In the example of FIG. 2A, the user interface 200 can also include a status bar 209 that displays text-based messages to the user during or after gameplay. The user interface 200 can also include an input interface 210 that allows users to select a bet amount with incremental increases or decreases as well as a maximum bet option. The input interface 210 can also include a spin/play button with an auto-play option which may increase the speed of gameplay. The user interface 200 can further include a status region 212, which may display a current balance in the form of credits which may be transferred to play other games or used for other purposes. The status region 212 may also display information such as a current bet amount, a current win amount, the time of day, and other such information.

Initially, in an early stage of gameplay or after a jackpot win, the jackpot level visual indicator 204 can appear in the first state 201A. The first state 201A can include a static image with a pair of doors 205 in a closed state. The pair of doors 205 can depict a dragon image split between two unopened doors. As users play the primary game, they can develop an association with the visual indicator 204 being in the first state 201A with the pair of doors 205 in the closed position. This visual indicator 204 being in the first state 201A can be associated with a first, lower probability of triggering play of the secondary game as compared to higher probabilities of triggering play of the secondary game as the current jackpot level increases.

The wild symbol 208A appearing on one or more of the virtual reels 207B, 207C, 207D can trigger a first coinflip mechanic that determines whether to increment a current jackpot level, for instance, to a second level as depicted in the example of FIG. 2B. Regardless of the outcome of the first coinflip mechanic, detection of the wild symbol 208A can also trigger activation of a second coinflip mechanic that is used to determine whether to trigger a bonus game.

FIG. 2B depicts the user interface 200 of the primary game with the jackpot level visual indicator 204 in a second state 201B according to one or more embodiments. Transitioning from the first state 201A of the user interface 200 as depicted in FIG. 2A to the second state 201B of the user interface 200 as depicted in FIG. 2B can occur, for example, based on a combination of the wild symbol 208A appearing on one or more of the virtual reels 207B, 207C, 207D triggering a first coinflip mechanic that determines whether to increment the current jackpot level. As previously noted, as a result of determining that the first coinflip mechanic indicated incrementing of the current jackpot level, the visual indicator 204 can be updated to transition from being in the first state 201A with the pair of doors 205 in the closed position as in FIG. 2A to the pair of doors 205 being in a partially opened position with a changing image intensity effect. For instance, the changing image intensity effect may have a pulsating or glowing effect, with lightning or energy discharge type effects along with a glowing mouth and eyes of the character depiction, such as a dragon.

Other aspects of the user interface 200 may stay substantially similar when transitioning from the first state 201A of FIG. 2A to the second state 201B of FIG. 2B. The visual change of the visual indicator 204 also provides feedback to the user that the odds of reaching the bonus game have increased as compared to the first state 201A of the visual indicator 204 in FIG. 2A. Upon determining that one or more wild symbols 208A have been revealed in a subsequent spin of the virtual reels 207A-207E while in the second state 201B, the first coinflip mechanic can determine whether to increment a current jackpot level. As a result of determining that the first coinflip mechanic indicated incrementing of the current jackpot level, the visual indicator 204 can be updated to transition from being in the second state 201B with the pair of doors 205 in the partially opened position as in FIG. 2B to the pair of doors 205 being in a fully opened position and no longer visible as in FIG. 2C. Regardless of the outcome of the first coinflip mechanic, detection of the wild symbol 208A can also trigger activation of the second coinflip mechanic that is used to determine whether to trigger the bonus game.

FIG. 2C depicts a user interface 200 of the primary game with the jackpot level visual indicator 204 in a third state 201C according to one or more embodiments. In the third state 201C, the opening the pair of doors 205 of FIGS. 2A and 2B reveals an animated character 214. The third level associated with the third state 201C can include a changing background 215 with pulsating movement of the animated character 214, for example. This further change in the visual indicator 204 provides the user with feedback that the probability of triggering the bonus game has increased as compared to the second level associated with the second state 201B of FIG. 2B upon one or more wild symbols 208A appearing on virtual reels 207B-207D. Similar to FIGS. 2A and 2B, the appearance of one or more wild symbols 208A can also trigger activation of the second coinflip mechanic that is used to determine whether to trigger the bonus game.

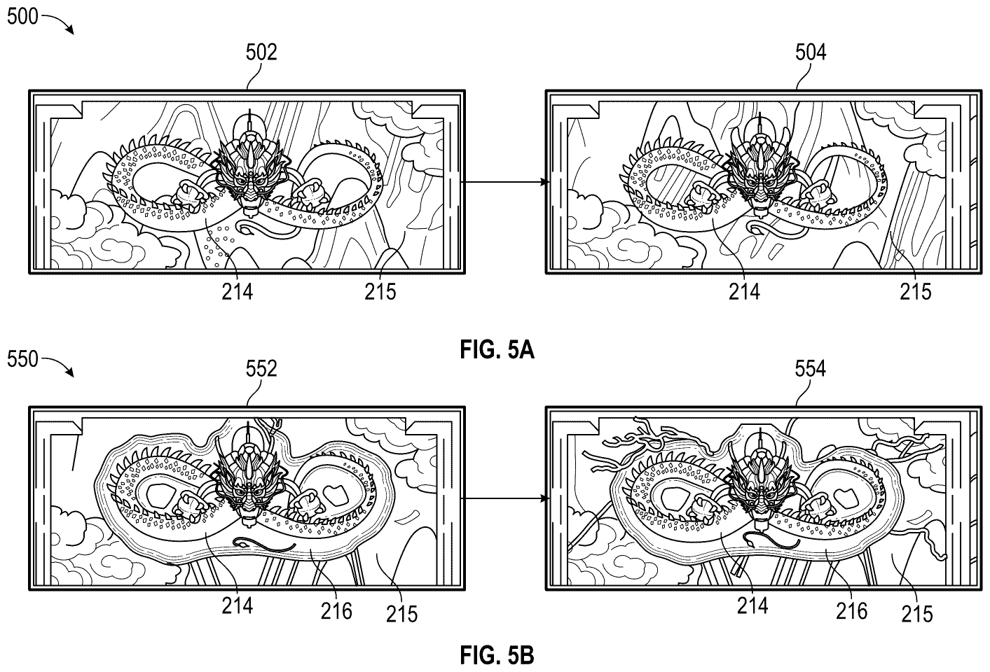

An example of the change in the visual indicator 204 in the third state 201C is further illustrated in FIG. 5A, which depicts an animation sequence 500 between a first image state 502 and a second image state 504. The animation sequence 500 can include a changing of the background 215 with pulsating movement of an animated character 214 between the first image state 502 and the second image state 504 according to one or more embodiments. There can be many image states in the animation sequence 500 beyond the examples depicted in the first image state 502 and the second image state 504. A rate of transition from the first image state 502 to the second image state 504 and to other image states can give an appearance of a higher level of agitation as compared to animation effects of the second state 201B of the visual indicator 204 in FIG. 2B.

FIG. 2D depicts a user interface 200 of the primary game with the jackpot level visual indicator 204 in a fourth state 201D according to one or more embodiments. A transition from the third level associated with the third state 201C of FIG. 2C to a fourth level associated with the fourth state 201D can include, for example, a removal of color from the animated character 214. Further, the fourth level can include a glowing region 216 around the animated character 214. This further change in the visual indicator 204 provides the user with feedback that the probability of triggering the bonus game has increased as compared to the third level associated with the third state 201C of FIG. 2C upon one or more wild symbols 208A appearing on virtual reels 207B-207D. Similar to FIGS. 2A-2C, the appearance of one or more wild symbols 208A can also trigger activation of the second coinflip mechanic that is used to determine whether to trigger the bonus game.

In this example, the fourth level is the highest level. Therefore, further results of spins that include one or more of the wild symbol 208A can avoid activating the first coinflip mechanic and may only activate the second coinflip mechanic to determine whether to trigger the bonus game. Upon reaching the bonus game and winning a jackpot prize, the user interface 200 can revert to the first level with the jackpot level visual indicator 204 appearing in the first state 201A of FIG. 2A.

An example of the change in the visual indicator 204 in the fourth state 201D is further illustrated in FIG. 5B, which depicts an animation sequence 550 between a first image state 552 and a second image state 554. The animation sequence 550 can include a changing of the background 215 with pulsating movement of an animated character 214 and a change in a glowing effect 216 around the animated character 214 between the first image state 552 and the second image state 554 according to one or more embodiments. There can be many image states in the animation sequence 550 beyond the examples depicted in the first image state 552 and the second image state 554. A rate of transition from the first image state 552 to the second image state 554 and to other image states can give an appearance of a higher level of agitation as compared to animation effects of the third state 201C of the visual indicator 204 in FIG. 2C and the second state 201B of the visual indicator 204 in FIG. 2B.

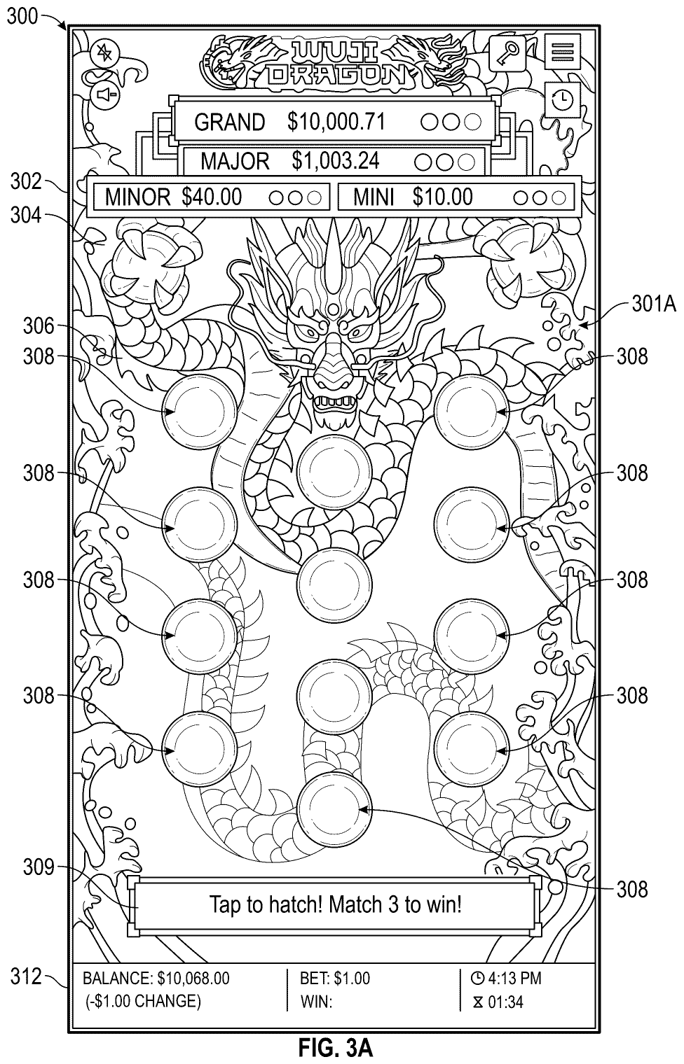

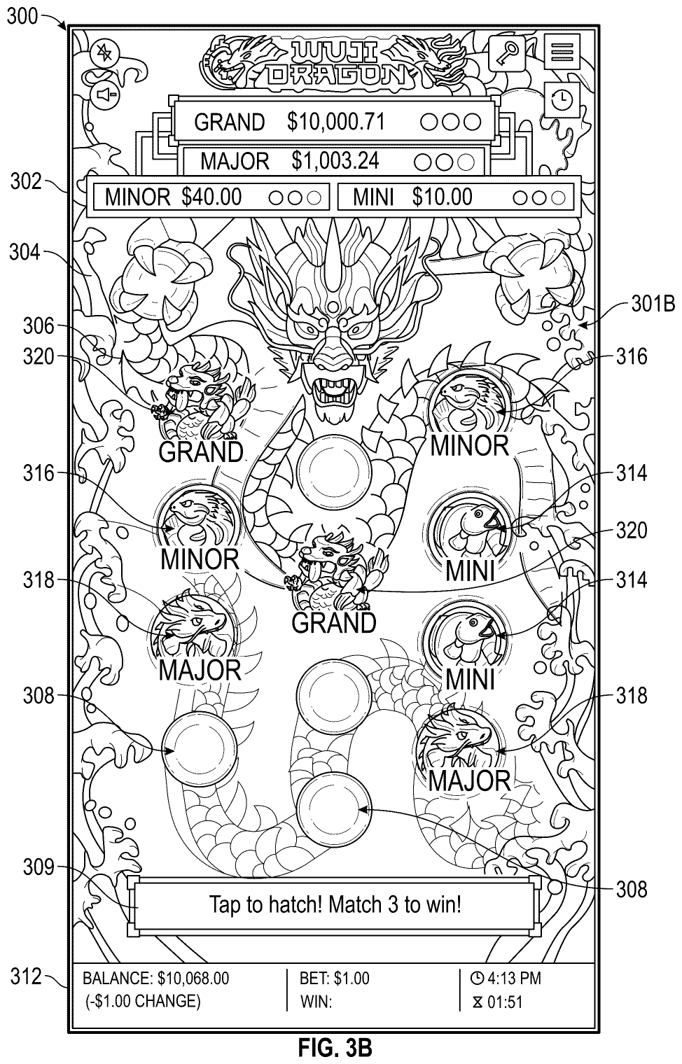

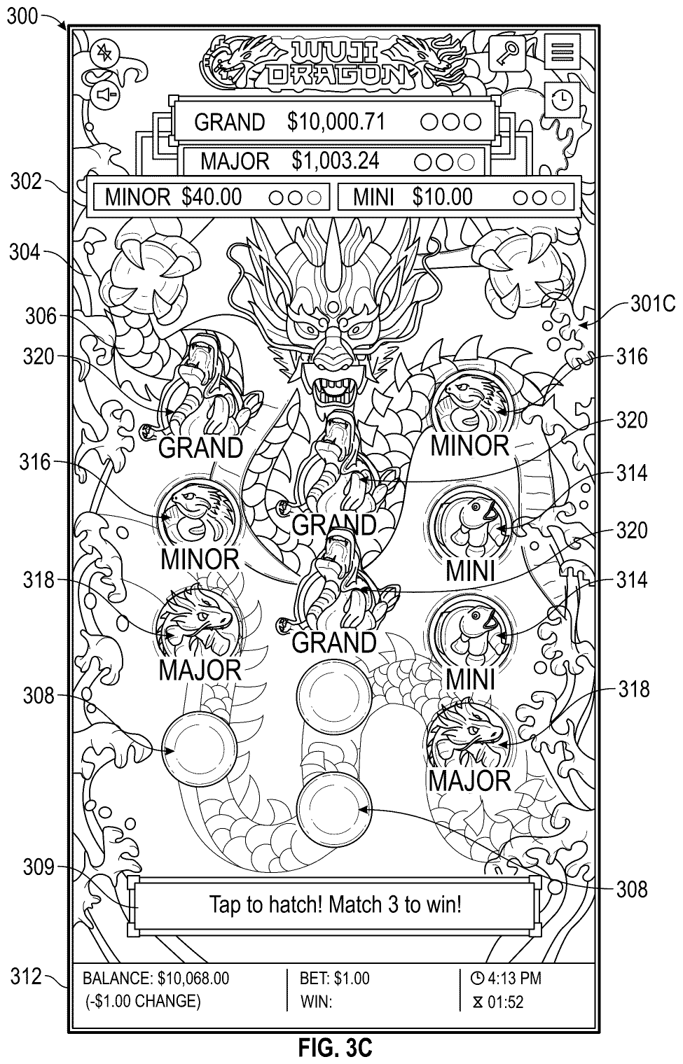

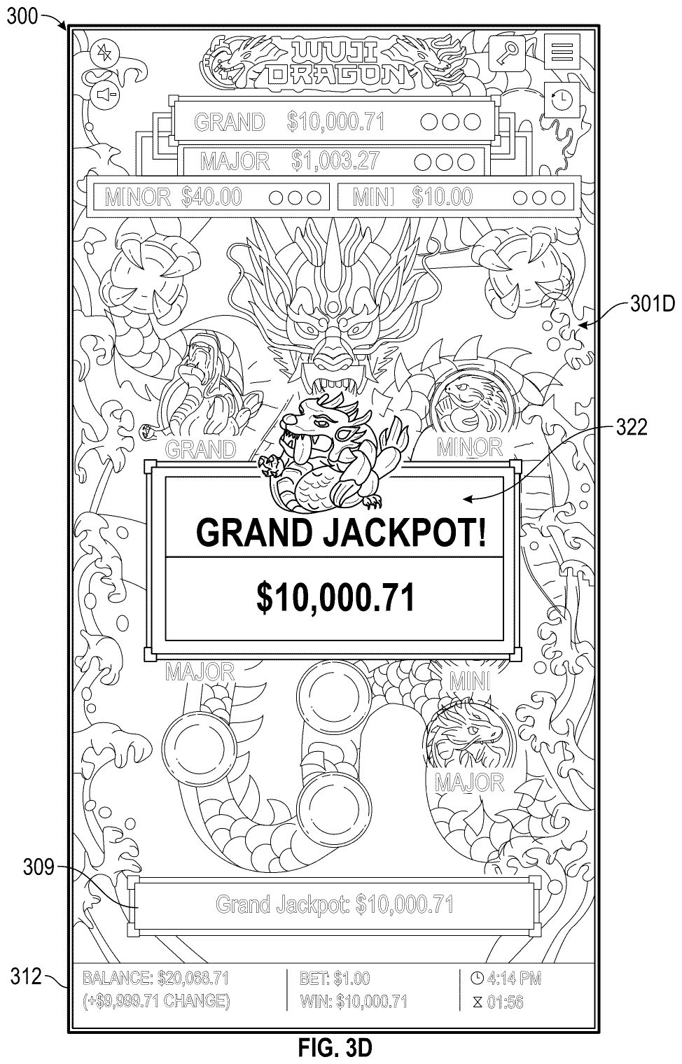

FIG. 3A depicts a user interface 300 of a bonus game in a first state 301A according to one or more embodiments. The bonus game depicted in the user interface 300 includes a jackpot amount indicator 302 that can express the value of multiple possible levels of jackpots which may be won upon playing the bonus game. As one example, there can be four jackpot levels, such as mini, minor, major, and grand that vary in value and in probability of winning. The user interface 300 can depict a background 304 and a bonus character 306, such as a large dragon. Further, the user interface 300 can display a plurality of coins 308 in a state that hides the value of each of the coins 308. The player can tap the coins 308 to reveal coin symbols, where revealing three coin symbols of a same type can result in winning the jackpot amount associated with the coin type. The user interface 300 can also include a status bar 309 that displays text-based messages to the user during or after gameplay. The user interface 300 can further include a status region 312, which may display a current balance in the form of credits which may be transferred to play other games or used for other purposes. The status region 312 may also display information such as a current bet amount, a current win amount, the time of day, and other such information. As a user taps the coins 308, the state of the bonus game advances.

FIG. 3B depicts a user interface 300 of the bonus game in a second state 301B according to one or more embodiments. As the user taps the coins 308, the coins 308 can reveal symbols such as a mini symbol 314, a minor symbol 316, a major symbol 318, or a grand symbol 320. In this example, the first matching three symbols can result in the user winning the jackpot prize associated with the symbol as depicted by the jackpot amount indicator 302.

FIG. 3C depicts a user interface 300 of the bonus game in a third state 301C according to one or more embodiments. In the example of FIG. 3C, three grand symbols 320 were revealed based on the user tapping selected coins 308. This results in a win of the grand jackpot prize amount.

FIG. 3D depicts a user interface 300 of the bonus game in a fourth state 301D according to one or more embodiments. Upon winning one of the jackpots, such as the grand jackpot, a prominent winning notification 322 can be displayed. Further, the status bar 309 can display a text-based message indicating the win, and the status region 312 can be updated to add the grand jackpot prize amount to the balance of the user, less any amount paid to place a bet resulting in the win.

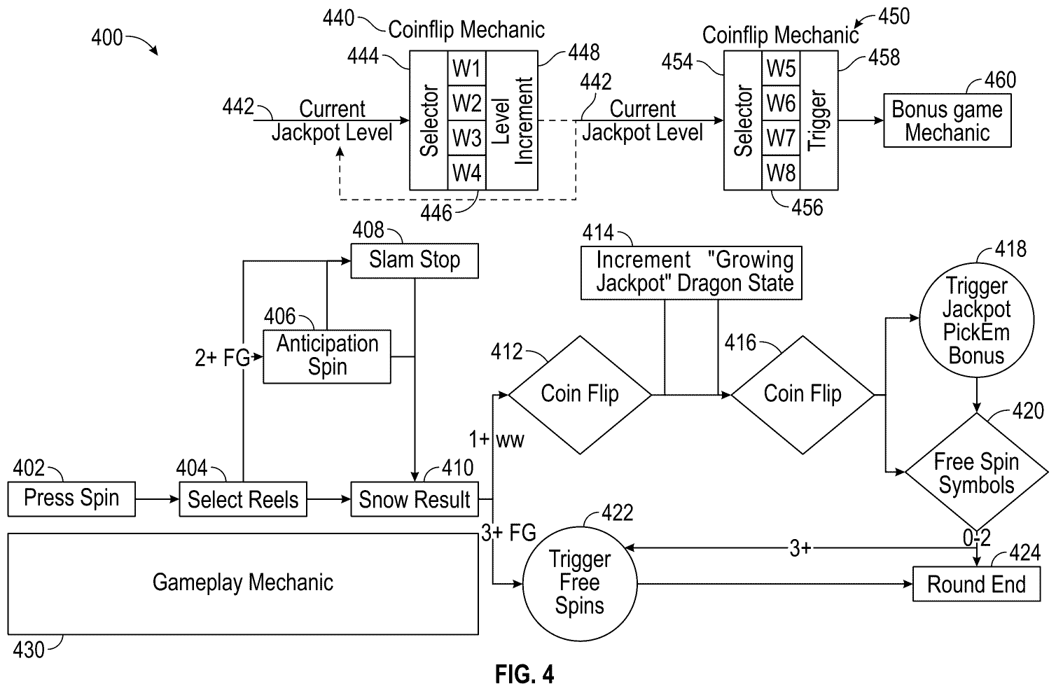

FIG. 4 is a flow diagram 400 of a gameplay process with associated mechanics according to one or more embodiments. The logic and flow depicted in the flow diagram 400 can be implemented by the user experience manager 116, process control logic 118, and/or other components of the system 10 of FIG. 1. In the example of FIG. 4, the gameplay process can be managed by a gameplay mechanic 430 that includes detecting a press of a spin request at block 402. At block 404, virtual reels 207A-207E of FIGS. 2A-2D can be selected to determine a spin result. If two or more of the symbols revealed from the spin are the free spin symbols 208B, this can result in an anticipation spin at block 406. A slam stop of the virtual reels 207A-207E can occur at block 408. At block 410, spin results can be displayed on the user interface 200. Where results of the spin include one or more of the wild symbols 208A, at block 412, a coinflip can be performed using, for instance, a first coinflip mechanic 440 to determine whether to increment a growing jackpot state in block 414.

The first coinflip mechanic 440 can receive a current jackpot level 442 at a selector 444. Based on the current jackpot level 442, the selector 444 can select one of a plurality of weight values 446, where each of the weight values 446 is associated with a specific level, such as weight_1 being associated with a first level, weight_2 being associated with a second level, weight_3 being associated with a third level, and weight_4 being associated with a fourth level. In some aspects, weight_4 can be omitted if it is a zero amount. A level increment 448 can determine whether the first coinflip mechanic 440 with the selected weight value 446 resulted in incrementing the current jackpot level 442. The current jackpot level 442 can be fed back as input to the first coinflip mechanic 440 and can be input to a second coinflip mechanic 450.

In the example of FIG. 4, the second coinflip mechanic 450 can receive the current jackpot level 442 at a selector 454. Based on the current jackpot level 442, the selector 454 can select one of a plurality of weight values 456, where each of the weight values 456 is associated with a specific level, such as weight_5 being associated with a first level, weight_6 being associated with a second level, weight_7 being associated with a third level, and weight_8 being associated with a fourth level. A trigger 458 can determine whether the second coinflip mechanic 450 with the selected weight value 446 resulted in triggering a bonus gameplay mechanic 460. This is further illustrated through coinflip 416 resulting in triggering a jackpot bonus game at block 418. At block 420, a further check can include looking for free spin symbols 208B at block 420, where three or more of the free spin symbols 208B can result in a transition to block 422, similar to a transition from block 410 to block 422, where three or more free spin symbols 208B cause the transition for multiple free spins of the primary game. A current round can end at block 424.

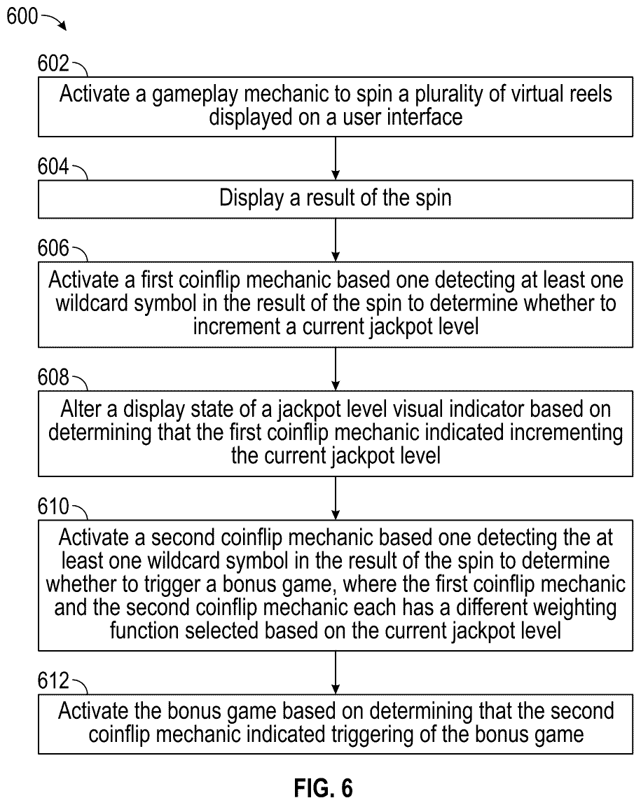

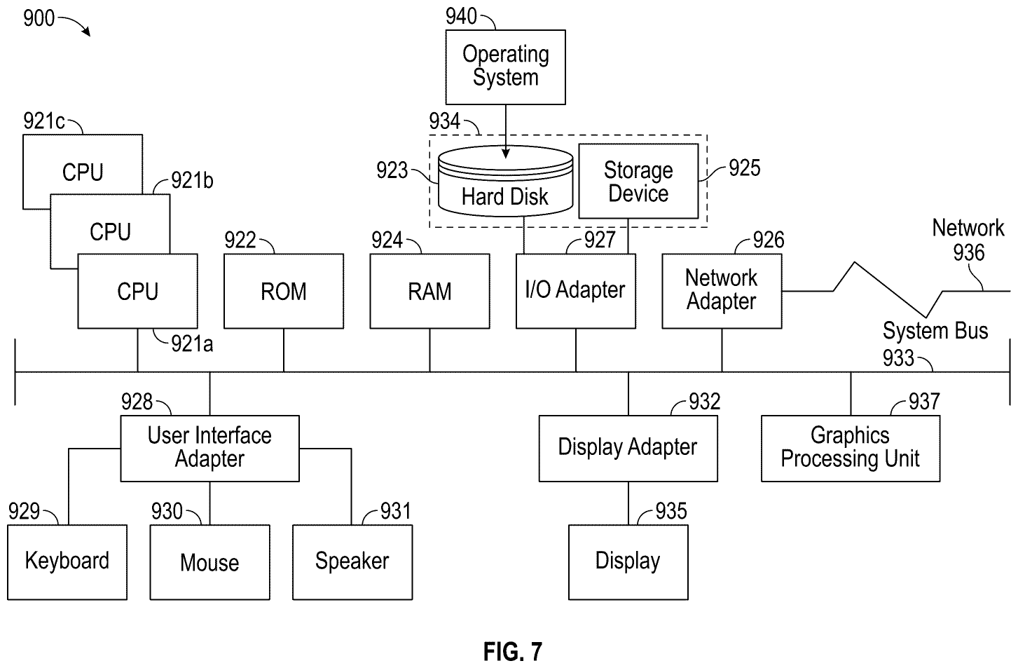

FIG. 6 is a flow diagram of a method 600 for bonus game activation according to one or more embodiments described herein. The method 600 can be implemented by any suitable device or system, such as the processing system 100 of FIG. 1 and/or the processing system 900 of FIG. 7 as a computer-implemented method. For example, the method 600 can be performed by the processing device 112 executing computer readable instructions stored in the memory 114 to perform functions of the user experience manager 116 and/or process control logic 118 of FIG. 1. Further, aspects of the method 600 can be performed in a distributed manner, such as portions being performed by one or more of the servers 102, user devices 104, processing system 100, and/or other cloud-based resources. The method 600 is described with reference to FIGS. 1-5B.

At block 602, a gameplay mechanic 430 is activated to spin a plurality of virtual reels 207A-207E displayed on a user interface 200 as part a primary game. This can be performed as a spin request at block 402 in response detecting an input from the input interface 210, such as tapping a spin/play button or a spin request from an auto-play input. At block 604, a result of the spin is displayed, which can include three symbols per reel of the virtual reels 207A-207E in the main gameplay region 206. At block 606, a first coinflip mechanic 440 is activated based one detecting at least one wildcard symbol 208A in the result of the spin to determine whether to increment a current jackpot level. At block 608, a display state of a jackpot level visual indicator 204 is altered based on determining that the first coinflip mechanic 440 indicated incrementing of the current jackpot level. At block 610, a second coinflip mechanic 450 is activated based one detecting the at least one wildcard symbol 208A in the result of the spin to determine whether to trigger a bonus game, where the first coinflip mechanic 440 and the second coinflip mechanic 450 each has a different weighting function selected based on the current jackpot level. At block 612, the bonus game is activated based on determining that the second coinflip mechanic 450 indicated triggering of the bonus game.

According to some aspects, the first coinflip mechanic 440 can include a first set of at least two different weighting functions that increase or decrease a probability of the incrementing as the current jackpot level increases. For example, the first coinflip mechanic 440 can have four weighting functions, such as weight_1 being associated with a first level, weight_2 being associated with a second level, weight_3 being associated with a third level, and weight_4 being associated with a fourth level. As an example of the changes in probabilities, weight_1 can have a 1:11 yes-to-no probability ratio, weight_2 can have a 1:17 yes-to-no probability ratio, weight_3 can have a 1:24 yes-to-no probability ratio, and weight_4 can have a 0:0 yes-to-no probability ratio. It will be understood that the example probability ratios are only for purposes of explanation and are not limiting.

According to some aspects, the second coinflip mechanic 450 can include a second set of at least two different weighting functions that increase a probability of triggering the bonus game as the current jackpot level increases. For example, the second coinflip mechanic 450 can have four weighting functions, such as weight_5 being associated with a first level, weight_6 being associated with a second level, weight_7 being associated with a third level, and weight_8 being associated with a fourth level. As an example of the changes in probabilities, weight_5 can have a 1:99 yes-to-no probability ratio, weight_6 can have a 1:89 yes-to-no probability ratio, weight_7 can have a 1:79 yes-to-no probability ratio, and weight_8 can have a 1:69 yes-to-no probability ratio. It will be understood that the example probability ratios are only for purposes of explanation and are not limiting.

According to some aspects, the display state of the jackpot level visual indicator 204 can change from a static image to a dynamic image based on the current jackpot level increasing from a first level to a second level, such as transitioning from the first state 201A to the second state 201B.

According to some aspects, the static image can include a pair of doors 205 in a closed position and the dynamic image can include the pair of doors 205 in a partially opened position with a changing image intensity effect.

According to some aspects, a transition from the second level to a third level can include a opening the pair of doors 205 to reveal an animated character 214, and the third level can include a changing background 215 with pulsating movement of the animated character 214, such as transitioning from the second state 201B to the third state 201C. An example of animation at the third level can appear as the animation sequence 500.

According to some aspects, a transition from the third level to a fourth level (e.g., transitioning from the third state 201C to the fourth state 201D) can include a removal of color from the animated character 214, and the fourth level can include a glowing region 216 around the animated character 214. An example of animation at the fourth level can appear as the animation sequence 550.

According to some aspects, the current jackpot level and the current jackpot value can be saved for each wager amount of a player interacting with the user interface 200. A change in the wager amount to a previously played wager amount can revert to a previously saved state of the current jackpot level and the current jackpot value when the player last played at the previously played wager amount. Both the current jackpot level and the current jackpot value associated with the wager amount can be reset upon the player winning the jackpot bonus game. After playing the bonus game, the current jackpot level can be reset to an initial value (e.g., a first level). Game state and player tracking data can be stored, for example, in data storage 106, such that gameplay can be paused and resumed or initiated by the same user through a different user device 104 at a different time and/or location.

Additional processes also may be included, and it should be understood that the process depicted in FIG. 6 represents an illustration, and that other processes may be added or existing processes may be removed, modified, or rearranged without departing from the scope of the present disclosure.

Example embodiments of the disclosure include or yield various technical features, technical effects, and/or improvements to technology. Example embodiments of the disclosure provide visual and/or audio feedback to the user about a current probably of triggering play of a bonus game while playing a primary game. These aspects of the disclosure constitute technical features that yield the technical effect of indirect visual/audio status feedback (e.g., using a visual change indicator) without explicitly stating words or numbers and is performed in an efficient and effective way that cannot practically be performed in the human mind. As a result of these technical features and technical effects, a system in accordance with example embodiments of the disclosure represents an improvement to data processing and visual communication techniques. It should be appreciated that the above examples of technical features, technical effects, and improvements to technology of example embodiments of the disclosure are merely illustrative and not exhaustive.

It is understood that one or more aspects described herein is capable of being implemented in conjunction with any other type of computing environment now known or later developed. For example, FIG. 7 depicts a block diagram of a processing system 900 for implementing the techniques described herein. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display 935 (e.g., a display monitor) is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

It is to be understood that the block diagram of FIG. 7 is not intended to indicate that the processing system 900 is to include all of the components shown in FIG. 7. Rather, the processing system 900 can include any appropriate fewer or additional components not illustrated in FIG. 7 (e.g., additional memory components, embedded controllers, modules, additional network interfaces, etc.). Further, the aspects described herein with respect to processing system 900 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

In yet another exemplary embodiment a computer program product includes a computer readable storage medium having program instructions embodied therewith, where the computer readable storage medium is not a transitory signal per se, the program instructions executable by a processing device to cause the processing device to perform operations as disclosed above.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
activating, by a processing device, a gameplay mechanic to spin a plurality of virtual reels displayed on a user interface;
displaying a result of the spin;
activating, by the processing device, a first coinflip mechanic based one detecting at least one wildcard symbol in the result of the spin to determine whether to increment current jackpot level;
altering, by the processing device, a display state of a jackpot level visual indicator based on determining that the first coinflip mechanic indicated incrementing of the current jackpot level;
activating, by the processing device, a second coinflip mechanic based one detecting the at least one wildcard symbol in the result of the spin to determine whether to trigger a bonus game, wherein the first coinflip mechanic and the second coinflip mechanic each has a different weighting function selected based on the current jackpot level; and
activating, by the processing device, the bonus game based on determining that the second coinflip mechanic indicated triggering of the bonus game.

2. The computer-implemented method of claim 1, wherein the first coinflip mechanic comprises a first set of at least two different weighting functions that increase or decrease a probability of incrementing as the current jackpot level increases.

3. The computer-implemented method of claim 2, wherein the second coinflip mechanic comprises a second set of at least two different weighting functions that increase a probability of triggering the bonus game as the current jackpot level increases.

4. The computer-implemented method of claim 1, wherein the display state of the jackpot level visual indicator changes from a static image to a dynamic image based on the current jackpot level increasing from a first level to a second level.

5. The computer-implemented method of claim 4, wherein the static image comprises a pair of doors in a closed position and the dynamic image comprises the pair of doors in a partially opened position with a changing image intensity effect.

6. The computer-implemented method of claim 5, wherein a transition from the second level to a third level comprises a opening the pair of doors to reveal an animated character, and the third level comprises a changing background with pulsating movement of the animated character.

7. The computer-implemented method of claim 6, wherein a transition from the third level to a fourth level comprises a removal of color from the animated character, and the fourth level comprises a glowing region around the animated character.

8. The computer-implemented method of claim 1, wherein the current jackpot level and a current jackpot value are saved for each wager amount of a player interacting with the user interface, a change in the wager amount to a previously played wager amount reverts to a previously saved state of the current jackpot level and a current jackpot value when the player last played at the previously played wager amount, and both the current jackpot level and the current jackpot value associated with the wager amount are reset upon the player winning the jackpot bonus game.

9. A system comprising:
a memory comprising computer readable instructions; and
a processing device for executing the computer readable instructions, the computer readable instructions controlling the processing device to perform operations comprising:
activating a gameplay mechanic to spin a plurality of virtual reels displayed on a user interface;
displaying a result of the spin;
activating a first coinflip mechanic based one detecting at least one wildcard symbol in the result of the spin to determine whether to increment a current jackpot level;
altering a display state of a jackpot level visual indicator based on determining that the first coinflip mechanic indicated incrementing of current jackpot level;
activating a second coinflip mechanic based one detecting the at least one wildcard symbol in the result of the spin to determine whether to trigger a bonus game, wherein the first coinflip mechanic and the second coinflip mechanic each has a different weighting function selected based on the current jackpot level; and
activating the bonus game based on determining that the second coinflip mechanic indicated triggering of the bonus game.

10. The system of claim 9, wherein the first coinflip mechanic comprises a first set of at least two different weighting functions that increase or decrease a probability of incrementing as the current jackpot level increases.

11. The system of claim 10, wherein the second coinflip mechanic comprises a second set of at least two different weighting functions that increase a probability of triggering the bonus game as the current jackpot level increases.

12. The system of claim 9, wherein the display state of the jackpot level visual indicator changes from a static image to a dynamic image based on the current jackpot level increasing from a first level to a second level.

13. The system of claim 12, wherein the static image comprises a pair of doors in a closed position and the dynamic image comprises the pair of doors in a partially opened position with a changing image intensity effect.

14. The system of claim 13, wherein a transition from the second level to a third level comprises a opening the pair of doors to reveal an animated character, and the third level comprises a changing background with pulsating movement of the animated character.

15. The system of claim 14, wherein a transition from the third level to a fourth level comprises a removal of color from the animated character, and the fourth level comprises a glowing region around the animated character.

16. The system of claim 9, wherein the current jackpot level and a current jackpot value are saved for each wager amount of a player interacting with the user interface, a change in the wager amount to a previously played wager amount reverts to a previously saved state of the current jackpot level and the current jackpot when the player last played at the previously played wager amount, and both the current jackpot level and the current jackpot value associated with the wager amount are reset upon the player winning the jackpot bonus game.

17. A computer program product comprising a storage medium embodied with computer program instructions that when executed by a computer cause the computer to implement:
activating a gameplay mechanic to spin a plurality of virtual reels displayed on a user interface;
displaying a result of the spin;
activating a first coinflip mechanic based one detecting at least one wildcard symbol in the result of the spin to determine whether to increment a current jackpot level;
altering a display state of a jackpot level visual indicator based on determining that the first coinflip mechanic indicated incrementing of the current jackpot level;
activating a second coinflip mechanic based one detecting the at least one wildcard symbol in the result of the spin to determine whether to trigger a bonus game, wherein the first coinflip mechanic and the second coinflip mechanic each has a different weighting function selected based on the current jackpot level; and
activating the bonus game based on determining that the second coinflip mechanic indicated triggering of the bonus game.

18. The computer program product of claim 17, wherein the first coinflip mechanic comprises a first set of at least two different weighting functions that increase or decrease a probability of the incrementing the current jackpot level, and the second coinflip mechanic comprises a second set of at least two different weighting functions that increase a probability of triggering the bonus game as the current jackpot level increases.

19. The computer program product of claim 17, wherein the display state of the jackpot level visual indicator changes from a static image to a dynamic image based on the current jackpot level increasing from a first level to a second level, the static image comprises a pair of doors in a closed position and the dynamic image comprises the pair of doors in a partially opened position with a changing image intensity effect, a transition from the second level to a third level comprises a opening the pair of doors to reveal an animated character, and the third level comprises a changing background with pulsating movement of the animated character, and a transition from the third level to a fourth level comprises a removal of color from the animated character, and the fourth level comprises a glowing region around the animated character.

20. The computer program product of claim 17, wherein the current jackpot level and a current jackpot value are saved for each wager amount of a player interacting with the user interface, a change in the wager amount to a previously played wager amount reverts to a previously saved state of the current jackpot level and the current jackpot value when the player last played at the previously played wager amount, and both the current jackpot level and the current jackpot value associated with the wager amount are reset upon the player winning the jackpot bonus game.
